(19) United States
(12) Patent Application Publication
(10) Pub. No.: US 2016/0227281 A1
(43) Pub. Date: Aug. 4, 2016

(54) ADJUSTMENT OF MEDIA RECORDING SCHEDULE BASED ON BROADCAST CONTENT

(71) Applicant: International Business Machines Corporation, Armonk, NY (US)

(72) Inventors: Tamer E. Abuelsaad, Somers, NY (US); Gregory J. Boss, Saginaw, MI (US); John E. Moore, JR., Brownsburg, IN (US); Randy A. Rendahl, Raleigh, NC (US)

(21) Appl. No.: 14/612,360

(22) Filed: Feb. 3, 2015

(51) Int. Cl. H04N 21/458; H04N 21/234; H04N 21/44; H04N 21/2747; H04N 21/433; H04N 21/439; H04N 21/233; H04N 21/262

(52) U.S. Cl. CPC H04N 21/4583; H04N 21/233; H04N 21/23418; H04N 21/2625; H04N 21/2747; H04N 21/4334; H04N 21/4394; H04N 21/44008

(57) ABSTRACT

One or more processors receive input to record a scheduled program of broadcast media. The one or more processors analyze a pattern of content of currently broadcast media to determine if there is a schedule change for the program to record. If a schedule change is determined, based on content pattern analysis, the one or more processors initiate a recording activity for the scheduled program based on the change of schedule. According to another embodiment, the one or more processors receive a portion of content corresponding to a beginning pattern of the scheduled program of broadcast media. The one or more processors compare the currently broadcast content pattern to the portion of content corresponding to the beginning pattern of the program to be recorded. If a match is determined, a change of schedule for the scheduled program of broadcast media is determined by the one or more processors.

### BACKGROUND OF THE INVENTION

The present invention relates generally to the field of recording of broadcast media, and more particularly to adjusting the recording schedule based on pattern recognition of the broadcast content.

Viewers of television (TV) broadcast programs are able to selectively record scheduled programs and view the programs at a later time that is more convenient to the viewer. Recording of scheduled broadcast programs enables viewers to participate in activities regardless of time conflicts between the activities and the scheduling of TV programs the viewer desired to view. However, scheduled recording devices may be affected by unanticipated program broadcast delays, such as televised sporting events that extend past their designated end time, or unexpected interruptions during programming that affect the start or end time of the program to be recorded. The delays and interruptions result in partial recording of the desired program, omitting portions at the start or end of the program. In some cases, extended delays of program broadcasts result in a change of the channel on which the program is broadcast, and the information describing the channel change is only made available by broadcast message slightly before the scheduled start time of the program.

Methods of recording TV broadcast programs include manual time settings for the channel on which the program is scheduled to be broadcast, as well as the beginning and ending time of recording. Other methods rely on information carried within the broadcast signal to provide start and stop indicators for scheduled TV programs, and may include schedule updates for near-term programming. Such methods rely on the broadcasting source and the recording device to mutually communicate via the embedded signal, which may require the devices to be enabled with a set of application programming interfaces (APIs). The APIs may not be uniformly standardized and accepted across broadcasting sources and device manufacturers, often requiring owners of recording devices to purchase additional equipment to enhance their recording device.

Other options, such as “on-demand” viewing of post-broadcast TV programs and movies, offer limited selection and may be subject to restrictions and/or limited availability.

### SUMMARY

According to one embodiment of the present invention, a method, computer program product, and system for recording a scheduled broadcast is provided. The method for recording the scheduled broadcast includes one or more processors that receive input to record a scheduled program of broadcast media. The one or more processors analyze a pattern of content of a program of broadcast media currently being broadcast. The one or more processors determine whether there is a change of schedule for the scheduled program of broadcast media based, at least in part, on the pattern of content that is analyzed and, the one or more processors, responsive to determining a change of schedule for the scheduled program of broadcast media, initiate a recording activity for the scheduled program of broadcast media based on the change of schedule.

According to another embodiment, the method operation in which the one or more processors analyze the pattern of content of a program currently being broadcast and then determine whether there is a change of schedule for the scheduled program of broadcast media based, at least in part, on the pattern that is analyzed, includes an operation in which the one or more processors receive a portion of content corresponding to a beginning pattern of the scheduled program of broadcast media. The one or more processors determine whether the pattern of content of the program of broadcast media currently being broadcast matches the portion of content corresponding to the beginning pattern of the scheduled program of broadcast media and, the one or more processors, responsive to determining a match between the pattern of content of the program currently being broadcast and the portion of content corresponding to the beginning pattern of the scheduled program of broadcast media, determine a change of schedule for the scheduled program of broadcast media.

### BRIEF DESCRIPTION OF THE DRAWINGS

FIG. 1 is a functional block diagram illustrating a distributed data processing environment, in accordance with an embodiment of the present invention.

FIG. 2A is a functional block diagram illustrating program recording information flow, in accordance with an embodiment of the present invention.

FIG. 2B is a functional block diagram illustrating program recording information flow, in accordance with an embodiment of the present invention.

FIG. 3 is a flowchart depicting operational steps of a broadcast analysis module, inserted on a client device within the distributed data processing environment of FIG. 1, in accordance with an embodiment of the present invention.

FIG. 4 depicts a block diagram of components of the client computing device capable of executing the broadcast analysis program, in accordance with an embodiment of the present invention.

### DETAILED DESCRIPTION

Embodiments of the present invention recognize that recording scheduled broadcast media can be affected by interruptions and delays to the scheduled broadcast. Such delays are common due to live sporting events broadcast on TV, which are shown in their entirety, and interruptions resulting from emergency announcements, breaking news, or election coverage, for example. Because broadcast program recordings are often based on time and duration, delays and interruptions result in partial recording of the targeted program. In some cases, information associated with a delay in initiating a subsequent media presentation, such as a TV program or movie broadcast, is included in a current media presentation. The information may include viewer instructions to change to a different channel in order to view the target program in its entirety. Some recording devices are unable to adjust to delays, interruptions, and changes to the channel or time of scheduled broadcast program. Embodiments of the present invention may be applied to a variety of scheduled audio and video media presentations, such as broadcast events that include, but are not limited to: television programs, movies, newscasts, documentaries, and discussions. Hereafter the term “program” will be used to reference one or more types of broadcast events, and “content” is used to collectively refer to types of broadcast media, such as, but not limited to, streaming or static video images, optical characters, and audio components of the program broadcast.

Some embodiments of the present invention include analysis of a broadcast stream of content at, or prior to, the scheduled start of a known or previously broadcast TV program targeted for recording. The content of the broadcast stream is sampled, and one or more elements of the content, such as images from video, characters determined by optical character recognition (OCR) within the video, and audio content are used to identify the start and/or end of the targeted program broadcast. The sampled content elements are compared to known content of the broadcast program or movie, received by the recording device by accessing a repository of known broadcast content, which is associated with the start and/or end of the particular program or movie. The recording device starts recording subsequent to the matching of the streaming content of the beginning of the targeted broadcast program to the known broadcast content received from the repository.

In other embodiments, the analysis of a broadcast stream includes identifying text characters using OCR techniques, and determining the information within the message by keyword recognition and semantic analysis. In some embodiments, the analyzed message indicates the anticipated delay of the start of the targeted broadcast program. The message may include an amount of time of delay anticipated, or the message may indicate the program targeted for recording is to be broadcast on a different channel and at a time designated within the character stream message. Such messages are often displayed along the top or bottom of the current broadcast stream image. In yet other embodiments, the duration of a broadcast interruption may be tracked and added to the start and/or end time of a subsequently broadcast program targeted for recording.

In yet other embodiments, the message may not include an estimated time of delay, but rather indicates the program being delayed will begin following the conclusion of the current program being broadcast. In such cases, the analysis of the broadcast stream determines the start time of the program targeted for recording by matching sampled content of the streaming broadcast to known images, characters, or audio content associated with the start of the program to be recorded.

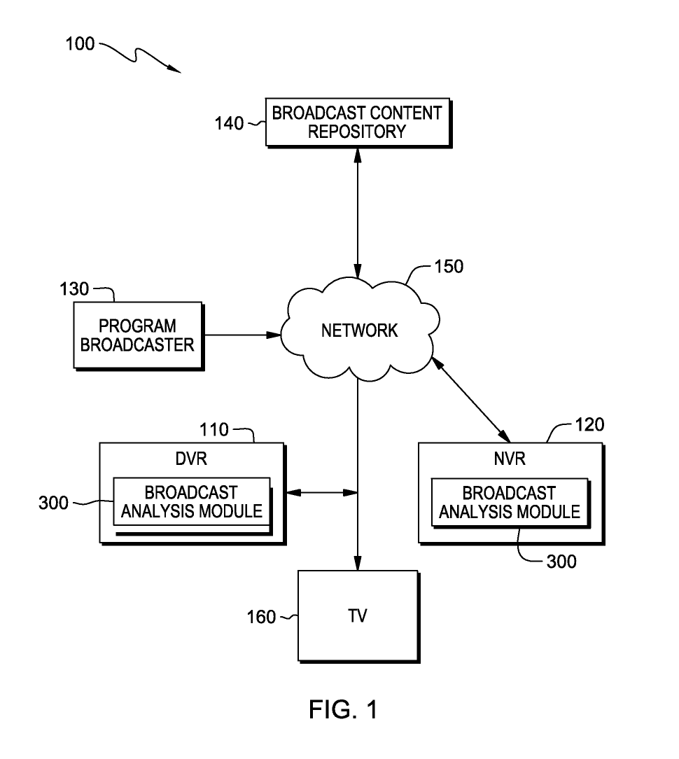

The present invention will now be described in detail with reference to the Figures. FIG. 1 is a functional block diagram illustrating a distributed data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes digital video recorder (DVR) 110, and network video recorder (NVR) 120, each hosting an instance of broadcast analysis module 300. Distributed data processing environment 100 also includes program broadcaster 130, broadcast content repository 140 and TV 160, all interconnected via network 150.

Network 150 may be, for example, a local area network (LAN), a telecommunications network, a wide area network (WAN), such as the Internet, a virtual local area network (VLAN), a cable broadcasting delivery network, a satellite broadcasting delivery network, or any combination that can include wired, wireless, or optical connections. In general, network 150 can be any combination of connections and protocols that will support communications between program broadcaster 130, broadcast content repository 140, DVR 110, and NVR 120, TV 160, and the operation of broadcast analysis module 300, within distributed data processing environment 100, in accordance with embodiments of the present invention.

TV 160 is a device that receives input from a broadcasting source via network 150 or from recorded content played back from DVR 110. In some embodiments of the present invention, TV 160 is a television, in other embodiments TV 160 is a computing system capable of receiving streaming content and displaying broadcast content or recorded content to viewers. In some embodiments, TV 160 receives playback of recorded content from NVR 120 via network 150. TV 160 displays broadcast content or recorded content that is played back for viewing by users of TV 160.

Broadcast content repository 140 is a remote storage structure in which instances of content corresponding to known broadcast program starts and endings are maintained. A “known” program is one that is scheduled for broadcast, and in some embodiments of the present invention, has access to content associated with the beginning and/or ending of the program. In some embodiments, the program has been previously broadcast and images associated with the start of the program are available and have been stored in broadcast content repository 140. In other embodiments, a known first program follows and/or precedes a second known program that has content available to compare to streaming broadcast content and is used to determine the beginning and/or ending of the first known program. The stored content may be one or more images from the video stream that corresponds to the opening scene or the introduction of a known program. In other embodiments, the content may include audio sampling of music and/or voice recordings associated with the start of a program. In yet other embodiments, OCR techniques are used to identify unique titles or credits associated with the start of a program. Similarly, broadcast content repository 140 includes content corresponding to the ending scene or closing of known programs. The content images, characters, or audio of repository 140 are identified as corresponding to one of a known multitude of programs, labeled similar in manner to the way in which the program is labeled when scheduled.

NVR 120 is a network video recording device associated with a network provider or network service. In some embodiments of the present invention, NVR 120 is capable of receiving input from TV 160, or devices operating through TV 160 (not shown). The input received by NVR 120 establishes one or more target programs to be recorded, and includes an option to enable broadcast analysis module 300 to adjust the recording of the target program in the event of a delay, interruption, or acknowledged change to the channel and/or time of broadcast. NVR 120 includes broadcast analysis module 300, which analyzes the broadcast stream and in one embodiment, identifies indicators of delay or interruption of the program targeted to record, and adjusts the recording of the program based on information provided in the broadcast stream, prior to the start of the program targeted for recording. In another embodiment, broadcast analysis module 300 obtains content associated with the start and ending of the program targeted for recording, from broadcast content repository 140, and uses the content from the repository to match a sampling of content from the broadcast stream. Matching of the start content is used to initiate the recording of the target program.

In some embodiments of the present invention, the repository content associated with the ending of the program targeted for recording is used to accurately determine the ending of the program. Broadcast analysis module 300 continues to operate during the recording of the target program, in case of interruption that may delay or otherwise affect the conclusion of the recorded program. In some embodiments of the present invention, inadvertent matching of scene images or audio content is avoided by delaying the matching operation of content until an approximate timeframe associated with the end of the target program. For example, if the program is scheduled for 1 hour, preview scenes displayed in the broadcast stream of the recorded program that occur 30 minutes into the program will be ignored, whereas images occurring within the program content 59 minutes after the start of the program are not ignored and may trigger the end of program recording.

DVR 110 is a digital video recording device that accesses the same broadcast stream received by TV 160. In some embodiments of the present invention, DVR 110 receives input to schedule the recording of one or more target programs, and includes an option to enable broadcast analysis module 300 to adjust the recording of the target program in the event of a delay, interruption, or acknowledged change to the channel and/or time of broadcast. DVR 110 includes broadcast analysis module 300, which analyzes the broadcast stream and, in one embodiment, identifies indicators of delay or interruption of the program targeted to record and adjusts the recording of the program based on information provided in the broadcast stream prior to the start of the program targeted for recording. DVR 110 and NVR 120 are depicted in distributed data processing environment 100 as alternative devices for scheduling program recordings

Broadcast analysis module 300, in one embodiment of the present invention, is hosted on DVR 110, and performs analysis of streaming broadcast content to determine whether the content includes information acknowledging a delay to a program's originally scheduled broadcast. Broadcast analysis module 300 performs optical character recognition techniques and employs semantic analysis to identify messages regarding delays to subsequently scheduled programs or interruptions to current programs that are displayed in peripheral areas of the current broadcast content. Broadcast analysis module 300 extracts the details of information included in the messages and applies the information by adjusting the recording start and end times of the program targeted to be recorded. The adjustment corresponds to the details of the information of the message. For example, the current streaming broadcast content includes a streaming message along the lower periphery of the display. The message includes characters that state that the program scheduled to follow the current program broadcast will be delayed by one-half hour. Broadcast analysis module 300 determines that a message is present, identifies the characters of the message, and uses semantic analysis to determine that the start and end of the program following the current broadcast program will be delayed by one-half hour. Broadcast analysis module 300 adjusts the start and end time of recording the targeted program, based on the information determined from the message within the streaming broadcast content.

In other embodiments of the present invention, broadcast analysis module 300 receives samples of known content of broadcast programs. The known content includes sampling of video images and/or audio content from programs previously broadcast and stored in a repository accessible via network connection, such as network 150. The known content may be identified and categorized to facilitate retrieval by broadcast analysis module 300, and includes content images or audio corresponding to the beginning and/or ending of the known broadcast program. Broadcast analysis module 300 receives content samplings of the known broadcast program beginning and/or ending, and analyzes the streaming broadcast content of TV programs by sampling the content, and compares the known content to the sampled streaming content to determine a match. Upon matching the content corresponding to the start of the program, broadcast analysis module 300 starts recording, and similarly, matching content corresponding to the end of the program triggers broadcast analysis module 300 to end the recording.

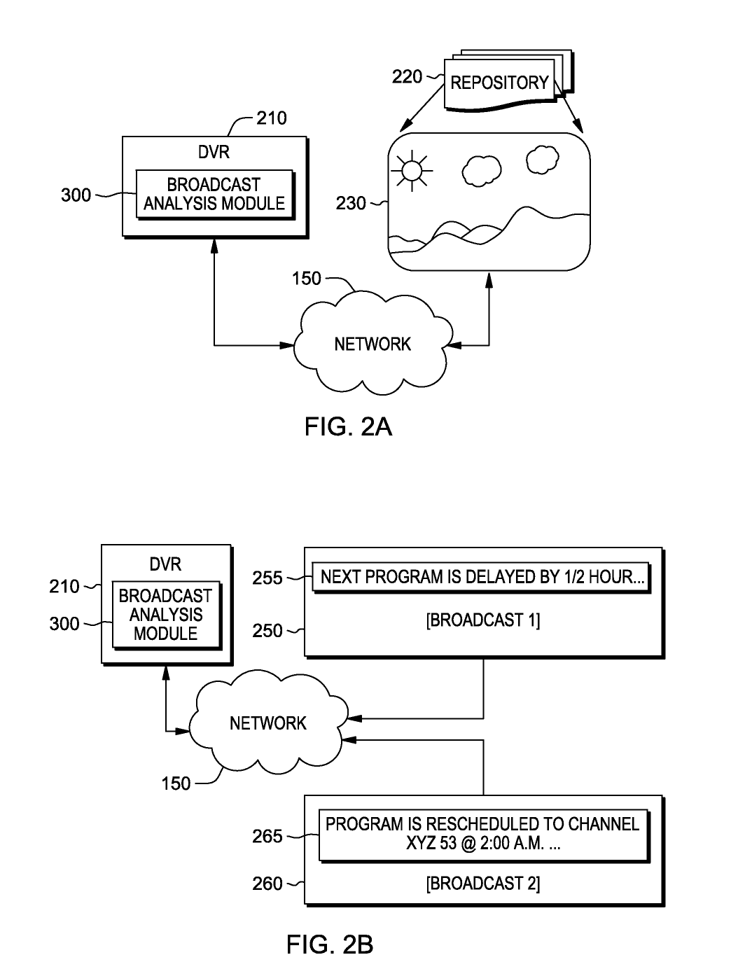

FIG. 2A is a functional block diagram illustrating an example of program recording information flow, in accordance with an embodiment of the present invention. FIG. 2A includes DVR 210, hosting broadcast analysis module 300, known content repository 220, and beginning image 230, connected via network 150. DVR 210 is a computing device capable of being programmed to record streaming broadcast content, such as content broadcast for TV viewing. Broadcast analysis module 300 is enabled to receive images and/or audio content from a repository of known broadcast content, such as repository 220, and compare the known content to analyzed streaming broadcast content to determine a match to the start or end of a program targeted for recording. Based on determining a match between the known content of the start of the targeted program and the analyzed streaming content of the broadcast, broadcast analysis module 300 starts recording the program. Similarly, matching known ending content of a program triggers broadcast analysis module 300 to end the recording of the targeted program.

Repository 220 is a network accessible repository of known television programs. In some embodiments of the present invention, repository 220 includes images corresponding to the beginning of known programs that are broadcast by broadcasting sources. The images can be one or more scenes corresponding to a program introduction, initial identifying symbols or scenes of a program, or the images can include characters corresponding to a title, episode, or credits of contributors to the program. In some embodiments, repository 220 can include audio content, which corresponds to music, sound, or speech associated with the start or end of a program.

Beginning image 230 is a scene from known content of a program targeted for recording based on user programming input received by DVR 210 and available to broadcast analysis module 300. In one embodiment of the present invention, beginning image 230 resides in repository 220 and is characterized and cataloged by an identifying program name. Broadcast analysis module 300 identifies the program targeted for recording and requests known content from repository 220 via the connection through network 150. The content may include one or more images associated with the start and/or end of the program to be recorded. In some embodiments of the present invention, the content received from repository 220 may be audio content, including music, sounds, and/or vocal speech, associated with the start and end of the program targeted for recording.

In some embodiments of the present invention, broadcast analysis module 300 receives input to DVR 210 designating a program to be recorded. Broadcast analysis module 300 requests known content from repository 220 corresponding to the program targeted for recording. Broadcast analysis module 300 receives images of the beginning and the ending of the targeted program and compares the known images to samplings of images of the streaming broadcast content on the channel designated for recording the targeted program. Broadcast analysis module 300 starts recording based on matching images sampled from the streaming broadcast content to the known images corresponding to the start of the targeted program. Similarly, broadcast analysis module 300 stops recording based on matching sampled images from the streaming broadcast content to the known images corresponding to the end of the targeted program. In some embodiments of the present invention, broadcast analysis module 300 may match music and/or voice recording audio content, or match characters of credits in the streaming broadcast content, to known audio or text content corresponding to the end of a program targeted for recording.

FIG. 2B is a functional block diagram illustrating an example of program recording information flow, in accordance with an embodiment of the present invention. FIG. 2B includes DVR 210, which hosts broadcast analysis module 300, broadcast 250, which includes streaming message 255, and broadcast 260, which includes streaming message 265, interconnected via network 150. DVR 210 is a computing device capable of being programmed to record streaming broadcast content, such as content broadcast for TV viewing. DVR 210 includes broadcast analysis module 300 which is capable of determining delays or interruptions indicated in broadcast messages, and adjusting the start and end of recording based on applying the information determined from the broadcast messages.

Broadcast 250 is streaming content for a television program, broadcast by a broadcasting source (not shown). In one embodiment of the present invention, broadcast 250 includes streaming content of a program that precedes a program targeted for recording, on the same channel. Broadcast 250 includes message 255 which, in one embodiment, is a text-based message that includes video images of characters displayed within the periphery of broadcast 250 content, and may be a static or scrolling message. In another embodiment, message 255 is displayed in a prominent position and covers the display of broadcast 250. For example, message 255 includes text displayed in a scrolling notification tape positioned at the top of the digital video content, and includes information indicating the delay of the subsequently scheduled broadcast program by one-half hour. In another embodiment, message 255 may be an audio message or speech included within the content of broadcast 250.

Broadcast 260 is streaming content for television, broadcast by a broadcasting source on a different channel than the streaming content of broadcast 250. In one embodiment of the present invention, broadcast 260 includes streaming content of a program that immediately precedes a program scheduled to be broadcast on the same channel and targeted for recording. Broadcast 260 includes message 265 which, in one embodiment, is a text-based message displayed within the periphery of broadcast 260 content, and may be a static message or a scrolling message. Message 265 indicates that a program scheduled to be broadcast has been rescheduled to a different channel and a different time.

In some embodiments of the present invention, broadcast analysis module 300 is included as part of the firmware of DVR 210. Broadcast analysis module 300 receives input to DVR 210 designating a program to be recorded, including a designated start and end time of the recording. Broadcast analysis module 300 begins analyzing the stream of broadcast content at a pre-determined amount of time prior to the scheduled start of the program targeted for recording. Broadcast analysis module 300 samples video content and analyzes for messages included within the broadcast content. By applying OCR techniques and semantic analysis, broadcast analysis module 300 identifies text characters within the video content of the broadcast and determines the information indicated by the text character message.

In one embodiment of the present invention, broadcast analysis module 300 analyzes message 255 and determines that the start and end of the scheduled program to be recorded will be delayed by one-half hour. Broadcast analysis module 300 adjusts the start and end time of the program recording to accommodate the delay, and continues to sample the broadcast content during the recording to determine and adjust for any subsequent delay or interruption.

In another embodiment of the present invention, broadcast analysis module 300 analyzes message 265 as part of the broadcast content of broadcast 260. Broadcast analysis module 300 applies OCR and semantic analysis techniques to the message identified in broadcast 260 and determines the message to indicate that the program targeted for recording is rescheduled to a different channel (XYZ 53) and at a different time (02:00 A.M.). Broadcast analysis module 300 adjusts the recording schedule and channel to reflect the change determined from the analysis of message 265.

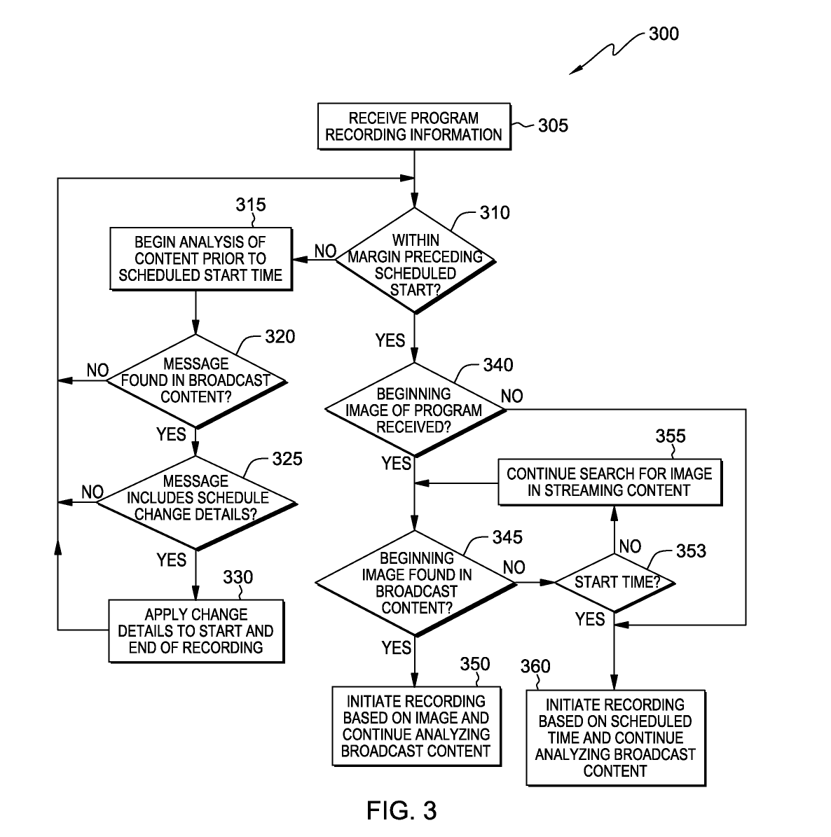

FIG. 3 is a flowchart depicting operational steps of broadcast analysis module 300, inserted on a client device within distributed data processing environment 100 of FIG. 1, in accordance with an embodiment of the present invention. Broadcast analysis module 300 receives program recording information (305). In some embodiments of the present invention, the received information includes the channel on which the program is to be broadcast, at least an approximate recording start time, and duration of the recording, or end-time of the recording. The received program recording information may also include program identification for use in retrieving program images or other program content from a repository of programming content, for example, broadcast content repository 140 (FIG. 1). In one embodiment, the information includes both a start time and an end time, or a start time and a duration time of the program broadcast. In yet another embodiment, the program recording information also includes receiving content associated with the program to be recorded, such as a set of images associated with the beginning of a program and a set of images associated with the end of the program. In other embodiments, the program recording information alternatively, or in addition, includes sampling of audio content respectively associated with the beginning and ending of a program. The images and/or audio content received from a repository of known program content may be used in some embodiments of the present invention, by broadcast analysis module 300, to determine the start and end of the program targeted for recording or, in other embodiments, broadcast analysis module 300 may use the images and/or audio content in a back-up role to confirm the respective start and end of the program to be recorded.

For example, broadcast analysis module 300 receives a channel designation, a start time, and a duration time for a program targeted for recording. Additionally, broadcast analysis module 300 obtains images associated with the start and the ending of the program targeted for recording, from broadcast content repository 140.

Having received recording information, broadcast analysis module 300 determines whether the current time is within a scheduled margin of the recording start time of the program (decision 310). In response to setting a time for recording a program, broadcast analysis module 300 continues to analyze the broadcast content of the channel on which the program is scheduled to be broadcast. The analysis of the broadcast content serves to identify and determine if a message is included, indicating a delay or interruption in the broadcast of the program targeted for recording. In some embodiments of the present invention, a user-setting of a margin indicates a time period preceding the scheduled start time of the program broadcast. For example, a margin may be set for five minutes preceding the scheduled start of the broadcast of a program to be recorded.

Having received recording information and determined that the current time is not within the margin preceding the scheduled start (310, “NO” branch), broadcast analysis module 300 analyzes the content being broadcast prior to the scheduled start time of the program to be recorded (315). The monitoring and analysis of the streaming broadcast is initiated prior to the scheduled start time of the program targeted for recording. In one embodiment of the present invention, the analysis of the streaming broadcast begins based on a preference setting of a time period prior to the scheduled start time received by broadcast analysis module 300. In another embodiment, the analysis of the streaming broadcast begins at a fixed time period before the start of the program targeted for recording, for example, a fifteen minute period of time before the targeted program start time. In yet another embodiment, the analysis of the broadcast stream begins in response to receiving the information associated with setting the program to record.

Broadcast analysis module 300 monitors the broadcast stream content by sampling the content at predefined intervals and analyzing the content. In one embodiment of the present invention, broadcast analysis module 300 analyzes the broadcast content to determine if there are characters within an image of the sampled broadcast stream. Analysis of an image sampled from the video stream to determine characters may be done using OCR techniques, for example. In another embodiment, broadcast analysis module 300 analyzes sampled images from the broadcast stream to perform object recognition within the sampled images.

While analyzing the broadcast stream content, broadcast analysis module 300 begins analysis of the content being broadcast prior to the schedule start time (315). In some embodiments of the present invention, the streaming content of the channel on which the target program is scheduled is sampled and analyzed using image and audio techniques, such as object recognition, optical character recognition (OCR), speech recognition, and key word recognition, for example. Object recognition may be used to identify scrolling banners that include delay information or screen symbols indicating interruption. OCR techniques may be used to further determine the content of scrolling or static messages included within broadcast images, and semantic analysis may be used to determine the meaning of the message content. Similarly, speech recognition may be used to identify an audio message within the broadcast content that indicates a delay or interruption.

For example, broadcast analysis module 300, using OCR techniques, determines characters within the sampled broadcast content that include “program”, “following”, “current”, “broadcast”, “conclusion”, and “delayed”, which match keywords accessible to broadcast analysis module 300, indicating a message that may change the broadcast schedule of the program targeted to record. Broadcast analysis module 300 performs semantic analysis on the recognized keywords and other OCR characters to determine the message content. In another embodiment of the present invention, broadcast analysis module 300 analyzes the audio component of the broadcast content and using speech recognition techniques, identifies keywords within the broadcast content indicating a message that may include a change to the targeted program broadcast schedule. Broadcast analysis module 300 applies semantic analysis to the identified keywords and other words from speech recognition techniques to determine the message within the broadcast content.

As analysis of the broadcast content is performed, broadcast analysis module 300 determines whether a message is found within the broadcast content (decision 320), and determining that there is a message in the broadcast content (320, “YES” branch), broadcast analysis module 300 determines whether the message includes schedule change details (decision 325). In some embodiments of the present invention, broadcast analysis module 300 combines the characters determined by OCR techniques, which are applied to the sampled broadcast content, and performs keyword recognition and semantic analysis to identify the message included within the broadcast content. In other embodiments, broadcast analysis module 300 parses and combines audio content and applies speech recognition to determine whether a message is included within the broadcast content.

Having analyzed the content and finding a message within the content of the broadcast preceding the program targeted for recording, broadcast analysis module 300 determines if the message includes schedule change details for the program to be recorded (decision 325). Schedule change details include particular information regarding the scheduling of the program to be broadcast subsequent to the program currently being broadcast. For example, the schedule change details may include the duration of the anticipated delay before the program following the current broadcast begins, such as “the program scheduled to begin at 4:00 P.M. will be delayed for one half hour and begin at 4:30 P.M. on this channel”. Other examples of messages, but not an exhaustive listing, may include, “The program scheduled for this time will be shown in its entirety following the conclusion of the current program broadcast” or, “The program originally scheduled for this time will be broadcast on alternate channel XYZ 53, @ 2:00 A.M.”.

Determining that the message identified within the broadcast content includes schedule change details for the program targeted for recording (step 325, “YES” branch), broadcast analysis module 300 applies the change details to the start and end times for recording (step 330). In some embodiments of the present invention, broadcast analysis module 300 applies a delay duration time interpreted from the message identified within the broadcast content to the start time of the program targeted for recording. For example, if the message indicated a one-half hour delay in the start of the program, broadcast analysis module 300 would adjust the start time of the program targeted for recording by an additional one-half hour. If the recording information received by broadcast analysis module 300 included a duration or a stop time, the end time would also be adjusted by the one-half hour delay duration.

In other embodiments, the details of the message identified from the broadcast stream content may include a change of the channel and broadcast time of the program targeted to be recorded. For example, if the amount of delay of the current broadcast program is excessive, the broadcasting source may decide to broadcast the delayed program on another channel, and may elect to do so at a later time. The message included in the broadcast stream content depicts the change of broadcast channel and time, and is analyzed by broadcast analysis module 300. Broadcast analysis module 300 adjusts the start time of the program recording to reflect the new start time, and adjusts the channel tuner to the channel indicated within the details of the message.

In yet other embodiments in which content segments corresponding to the start and end of the program to be recorded have been received from a repository of program content segments, broadcast analysis module 300 begins recording based on matching the repository content segments to sampling of the broadcast content. Similarly, broadcast analysis module 300 may terminate recording based on repository content segments known to match the content of the program's end. Content segments may include images respectively associated with the beginning and end of a program, audio content, such as music or voice samples respectively associated with the beginning and end of the program, or OCR of titles, credits or other characters or symbols, respectively associated with the beginning and end of the program.

Referring back to the case in which broadcast analysis module 300 has begun monitoring and analyzing the content of the broadcast stream and determines that a message is not detected within the content of the current program broadcast (320, “NO” branch), broadcast analysis module 300 returns to determine whether the current time is within the margin preceding the scheduled recording start time (310), and proceeds as described above. In some embodiments of the present invention, broadcast analysis module 300 analyzes the broadcast content for a configurable period of time, sampling content segments and determining if a message is found, and failing to find a message, returns to determine if the current time falls within the pre-defined margin preceding the start of recording.

Referring back to the case in which broadcast analysis module 300 has found a message within the streaming broadcast content, but determines that the message does not include schedule change details (325, “NO” branch), broadcast analysis module 300 returns to determine whether the current time is within the margin preceding the scheduled recording start time (310), and proceeds as described above.

In response to determining that the current time is within the margin preceding the scheduled start of the program broadcast (310, “YES” branch), broadcast analysis module 300 determines whether the beginning image of the program has been received (decision 340). In some embodiments of the present invention, broadcast analysis module 300 previously received program recording information (305), including known images of broadcast content from a repository of known content images. The images received from the repository include identification information corresponding to the beginning and/or ending of a particular program and, in some instances, a particular episode. Broadcast analysis module 300 determines whether the received content corresponds to the beginning of the program targeted for recording. Determining that the received images are known to correspond to the beginning of the program to record (340, “YES” branch), broadcast analysis module 300 determines whether a beginning image is found within the broadcast content (decision 345). Although reference is made to the content received from a repository as being images known to correspond to the beginning (and or ending) of the program to be recorded, it is acknowledged that the content received from the repository, known to correspond to a program targeted for recording, may alternatively, or in addition, include video images of program scenes from the beginning and/or ending of the program, video images of characters or symbols from the beginning and/or ending of the program, audio sampling from theme music, or vocal speech associated with the beginning and/or ending of the program. For convenience, references to “image” content received from a repository are understood by one of average skill in the art to additionally or alternatively include scenes, characters, symbols, music, or vocal speech content mentioned above.

Broadcast analysis module 300 analyzes the streaming broadcast content by sampling the content, such as images or audio segments. The sampling of streaming broadcast content is compared to the content corresponding to the beginning of the program, received from the repository, such as broadcast content repository 140. Broadcast analysis module 300 determines whether there is a match of the received content and the content sampled from the streaming broadcast. Determining the content from the repository to match the content sampled from the streaming broadcast (345, “YES” branch), broadcast analysis module 300 initiates recording of the program based on the matching of the content, and continues analyzing the broadcast content (350). Broadcast analysis module 300 continues to analyze the streaming broadcast content in the event of additional interruption and/or delay messages. If no content associated with the end of the program is received from the repository, then broadcast analysis module 300 applies additional interruption and/or delay time determined during the recording of the program, if any, to the program duration information or the program end time. Broadcast analysis module 300 ends program recording based on the scheduled program duration or scheduled end time and, if adjustments are made due to delays or interruptions during the program recording, the adjustments are appropriately applied to the program duration or scheduled end time.

For the case in which broadcast analysis module 300 determines that a beginning image of the program to be recorded has not been received (340, “NO” branch), broadcast analysis module 300 initiates recording of the program based on the scheduled time, and continues analyzing the broadcast content (360). The scheduled time may be adjusted based on applying the details of a message to the start and end of scheduled recording times, as described with regard to operation (330).

For example, if the beginning of the program targeted for recording is delayed by one-half hour, the end time of recording is extended by one-half hour. If the information associated with the program targeted for recording includes a start time and a duration of the program, and the analyzed message from the streaming broadcast content indicates a delay of one-half hour, then the end time is determined by increasing the duration of the program by the duration of the delay in the start of recording. Broadcast analysis module 300 determines the end time of the recording, ends the recording of the targeted program, and broadcast analysis module 300 ends.

The streaming broadcast content continues to be analyzed in the event of additional interruption and/or delay messages. If interruptions or delays are determined, subsequent to the start of recording the program, broadcast analysis module 300 adjusts the end of program recording by adding the determined delay duration to the program duration or end time. In response to concluding program recording, broadcast analysis module 300 ends.

For the case in which a beginning image of the program to be recorded has been received from the repository, and a corresponding beginning image has not been found within the streaming broadcast content (345, “NO” branch), broadcast analysis module 300 checks to determine if the current time matches the scheduled recording start time (decision 353), and determining that the scheduled recording start time does not match the current time (353, “NO” branch), broadcast analysis module 300 continues to search for a matching image in the streaming content (355). Broadcast analysis module 300 samples content from the streaming broadcast and, in one embodiment of the present invention, selects an image from a video frame, and compares the sampled image to the image received from the repository of known program content, which is associated with the beginning of the program to be recorded. In another embodiment, audio content is sampled by broadcast analysis module 300 and compared to audio content received from the repository of known program content. In some embodiments of the present invention, the streaming broadcast content is sampled at a pre-defined frequency, which may be configurable by a user or set to a default frequency. For example, video images may be sampled at a frequency of one image sample per two seconds of broadcast stream, and for a video frame count of thirty frames per second, the sampling frequency corresponds to one image for every sixty frames of streaming video. Broadcast analysis module 300 continues searching and determines if the beginning image received from the repository is found in the streaming broadcast content (345) and continues as described above.

For the case in which the corresponding beginning image has not been found within the streaming broadcast content, and broadcast analysis module 300 determines the current time to match the scheduled recording start time (353, “YES” branch), broadcast analysis module 300 initiates recording of the program based on the scheduled start time, and continues analyzing the broadcast content (360). If a delay or interruption is determined by broadcast analysis module 300 during the recording of the program, the duration of the delay or interruption is determined and added to the program duration or end time information, and broadcast analysis module 300 terminates recording based on the adjusted time.

In another embodiment of the present invention, the repository of broadcast content of known programs includes audio content, such as speech or music, associated with the beginning and/or ending of a known program. Sampling of audio content corresponding to the beginning of a program targeted for recording is received by broadcast analysis module 300. The sampling of audio content is compared to the audio component of the streaming broadcast content that corresponds to the program to be recorded. If a match is determined, broadcast analysis module 300 initiates recording of the program.

In yet other embodiments, the repository broadcast content of known programs may include character sets within the video images that are associated with titles or credits displayed at the beginning and/or ending of a program. The character sets received from the repository of known broadcast program content are analyzed by broadcast analysis module 300 using optical character recognition techniques, for example. The characters are compared to characters analyzed and identified within the streaming broadcast content to determine a match and, if found, broadcast analysis module 300 initiates and/or ends recording of the program.

In some embodiments of the present invention, the known program content received by broadcast analysis module 300 from a repository, such as broadcast content repository 140 (FIG. 1), includes content corresponding to the ending of the program. Broadcast analysis module 300 analyzes and compares the known content to the streaming broadcast content to determine a match, which indicates the ending of the program to be recorded. A match between the known program ending content and the streaming broadcast content of the program being recorded serves as a signal to end the recording.

In some embodiments of the present invention, determining whether priority of starting and ending program recording is based on images or scheduled (and adjusted) time, is determined by preference selections made by a user of broadcast analysis module 300. For example, the preference selection may indicate the start and end actions of the program recording are to be based on matching images sampled from the streaming broadcast content to images received from a repository of known broadcast program content, such as broadcast content repository 140. In other embodiments, the preference selection may indicate scheduled start and end times (and applied adjustments determined from analysis of streaming broadcast delay messages) are to be used to start and end program recording.

In another embodiment, subsequent to receiving input indicating the program targeted for recording, broadcast analysis module 300 actively requests known program content corresponding to the beginning and ending of the program targeted for recording from the repository of known broadcast content. Receipt of the known content by broadcast analysis module 300 establishes the priority of recording start and end to be based on matching content between known and streaming broadcast content. In yet other embodiments, a preference setting, in combination with receipt of requested known content, establishes that starting and ending the recording is based on matching of content. For the case in which receipt of the known content from the repository is lacking, broadcast analysis module 300 records the program based on time settings received and adjustments based on streaming broadcast messages indicating interruption or delay of the program targeted for recording.

Having determined the starting and stopping of program recording to be based on images of the streaming broadcast content, broadcast analysis module 300 matches the broadcast content to an ending image of the recorded program, and ends. Sampling of images of the streaming broadcast content are analyzed and compared to one or more images corresponding to the program being recorded, which are received from the repository of known broadcast program content. Matching of the one or more ending images of the known program content received from the repository to the sampled images from the streaming broadcast content triggers broadcast analysis module 300 to end the recording.

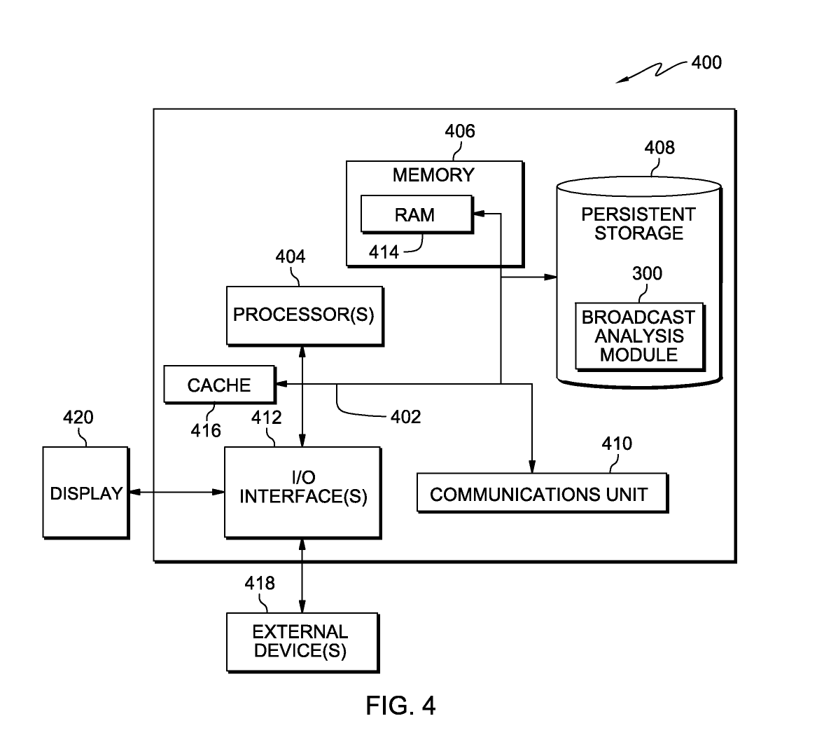

FIG. 4 depicts a block diagram of components of computing device 400 capable of performing the operational functions of DVR 110 and NVR 120, and capable of executing broadcast analysis module 300, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between computer processor(s) 404, memory 406, cache memory 416, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414. In general, memory 406 can include any suitable volatile or non-volatile computer-readable storage media.

Broadcast analysis module 300 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of distributed computer processing environment 100. In these examples, communications unit 410 includes one or more network interface cards. Communications unit 410 may provide communications through the use of either or both physical and wireless communications links. Broadcast analysis module 300 may be downloaded to persistent storage 408 through communications unit 410.

I/O interface(s) 412 allows for input and output of data with other devices that may be connected to DVR 110 and NVR 120. For example, I/O interface 412 may provide a connection to external devices 418 such as a keyboard, keypad, a touch screen, a remote control, and/or some other suitable input device. External devices 418 can also include portable computer-readable storage media such as, for example, thumb drives, portable optical or magnetic disks, and memory cards. Software and data used to practice embodiments of the present invention, e.g., broadcast analysis module 300 can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for recording a scheduled broadcast, the method comprising:
one or more computer processors receiving input to record a scheduled program of broadcast media;
the one or more computer processors analyzing a pattern of content of a program of broadcast media currently being broadcast;
the one or more computer processors determining whether there is a change of schedule for the scheduled program of broadcast media based, at least in part, on the pattern of content that is analyzed; and
the one or more computer processors, responsive to determining a change of schedule for the scheduled program of broadcast media, initiating a recording activity for the scheduled program of broadcast media based on the change of schedule.

2. The method of claim 1, wherein the program of broadcast media currently being broadcast is scheduled to precede the scheduled program of broadcast media.

3. The method of claim 2, wherein the pattern of content includes text-based information indicating a delay of broadcasting of the scheduled program of broadcast media.

4. The method of claim 3, wherein analyzing a pattern of content in the program of broadcast media currently being broadcast, comprises:
performing optical character recognition on the text-based information of the pattern of content.

5. The method of claim 1, wherein analyzing a pattern of content of a program currently being broadcast and determining whether there is a change of schedule for the scheduled program of broadcast media based, at least in part, on the pattern of content that is analyzed, comprises:
the one or more computer processors, receiving a portion of content corresponding to a beginning pattern of the scheduled program of broadcast media;
the one or more computer processors, determining whether the pattern of content of the program of broadcast media currently being broadcast matches the portion of content corresponding to the beginning pattern of the scheduled program of broadcast media; and
the one or more computer processors, responsive to determining a match between the pattern of content of the program currently being broadcast and the portion of content corresponding to the beginning pattern of the scheduled program of broadcast media, confirming a change of schedule for the scheduled program of broadcast media.

6. The method of claim 5, wherein the portion of content received from the external source includes a portion of content corresponding to an ending pattern of the scheduled program of broadcast media.

7. The method of claim 5, wherein the portion of content corresponding to a beginning pattern of the scheduled program includes a pattern of audio content.

8. The method of claim 1, wherein the recording activity includes at least one of starting a recording of the scheduled program of broadcast media, and ending the recording of the scheduled program of broadcast media.

9. The method of claim 1, wherein determining whether there is a change of schedule for the scheduled program of broadcast media includes determining a change to a channel on which the scheduled program of broadcast media is to be broadcast.

10. The method of claim 1, wherein the pattern of content of a program of broadcast media currently being broadcast includes a pattern of audio content.

11. The method of claim 1, wherein the recording activity corresponding to an end of the scheduled program of broadcast media is adjusted by an amount at least equal to a delay of the recording activity for a start of recording of the scheduled program of broadcast media.

12. The method of claim 1, wherein the pattern of content within a program of broadcast media currently being broadcast corresponds to an ending of a program scheduled to precede the scheduled program of broadcast media.

13. A computer program product for recording a scheduled broadcast, the computer program product comprising:
a computer-readable, non-transitory storage medium having program instructions embodied therewith, wherein the program instructions are executable by a computer processor, the program instructions comprising:
program instructions to receive input to record a scheduled program of broadcast media;
program instructions to analyze a pattern of content of a program of broadcast media currently being broadcast;
program instructions to determine whether there is a change of schedule for the scheduled program of broadcast media, based, at least in part, on the pattern of content that is analyzed; and
program instructions to, responsive to determining a change of schedule for the scheduled program of broadcast media, initiate a recording activity directed to the scheduled program of broadcast media, based on the change of schedule.

14. The computer program product of claim 13, further comprising:
program instructions to determine that the program of broadcast media currently being broadcast is scheduled to precede the scheduled program of broadcast media;
program instructions to determine that the pattern of content includes text-based information indicating a delay of broadcasting of the scheduled program of broadcast media; and
program instructions to perform optical character recognition on the text-based information of the pattern of content determined by analyzing the pattern of content in the program of broadcast media currently being broadcast.

15. The computer program product of claim 13, wherein the program instructions to analyze a pattern of content of a program currently being broadcast and determining whether there is a change of schedule for the scheduled program of broadcast media based, at least in part, on the pattern of content that is analyzed, comprises:
program instructions to receive a portion of content corresponding to a beginning pattern of the scheduled program of broadcast media;
program instructions to determine whether the pattern of content of the program of broadcast media currently being broadcast matches the portion of content corresponding to the beginning pattern of the scheduled program of broadcast media; and
program instructions to, responsive to determining a match between the pattern of content of the program currently being broadcast and the portion of content corresponding to the beginning pattern of the scheduled program of broadcast media, confirm a change of schedule for the scheduled program of broadcast media.

16. The computer program product of claim 15, wherein the portion of content corresponding to a beginning pattern of the scheduled program of broadcast media includes a pattern of audio content.

17. A computer system for recording a scheduled broadcast, the computer system comprising:
one or more computer processors;
one or more computer readable storage media; and
program instructions stored on the computer readable storage media for execution by at least one of the one or more processors, the program instructions comprising:
program instructions to receive user input to record a scheduled program of broadcast media;
program instructions to analyze a pattern of content of a program of broadcast media currently being broadcast;
program instructions to determine whether there is a change of schedule for the scheduled program of broadcast media based, at least in part, on the pattern of content that is analyzed; and
program instructions to, responsive to determining a change of schedule for the scheduled program of broadcast media, initiate a recording activity for the scheduled program of broadcast media, based on the change of schedule.

18. The computer system of claim 17, wherein the program instructions to analyze a pattern of content of a program currently being broadcast and determining whether there is a change of schedule for the scheduled program of broadcast media based, at least in part, on the pattern of content that is analyzed, comprises:
program instructions to receive, from an external source, a portion of content corresponding to a beginning pattern of the scheduled program of broadcast media;
program instructions to determine whether the pattern of content of the program of broadcast media currently being broadcast matches the portion of content corresponding to the beginning pattern of the scheduled program of broadcast media; and
program instructions to, responsive to determining a match between the pattern of content of the program currently being broadcast and the portion of content corresponding to the beginning pattern of the scheduled program of broadcast media, confirm a change of schedule for the scheduled program of broadcast media.

19. The computer system of claim 18, wherein the portion of content received includes a portion of content corresponding to an ending pattern of the scheduled program of broadcast media.

20. The computer system of claim 17, wherein the recording activity includes at least one of starting a recording of the scheduled program of broadcast media and ending the recording of the scheduled program of broadcast media.
